(19) United States
(12) Patent Application Publication
(10) Pub. No.: US 2025/0187838 A1
(43) Pub. Date: Jun. 12, 2025

(54) HOPPER

(71) Applicant: TOYOTA JIDOSHA KABUSHIKI KAISHA, Toyota-shi (JP)

(72) Inventors: Junichi Ishimoto, Okazaki-shi (JP); Kazuki Noritake, Nisshin-shi (JP); Yasushi Kato, Toyota-shi (JP); Kenichiro Muramatsu, Toyota-shi (JP)

(73) Assignee: TOYOTA JIDOSHA KABUSHIKI KAISHA, Toyota-shi (JP)

(21) Appl. No.: 18/937,280

(22) Filed: Nov. 5, 2024

(30) Foreign Application Priority Data
Dec. 11, 2023 (JP) 2023-208677

(51) Int. Cl. B65G 3/04; B65G 65/30

(52) U.S. Cl. CPC B65G 3/04; B65G 65/30

(57) ABSTRACT

A hopper having an openable and closable discharge outlet includes a partition plate that divides an inside of the hopper into a main storage chamber connected to the discharge outlet and a sub-storage chamber not connected to the discharge outlet. At least a part of the partition plate is a movable plate that is switchable between an opening state of opening a sub-discharge passage extending from the sub-storage chamber to the discharge outlet and a blocking state of blocking the sub-discharge passage.

### CROSS-REFERENCE TO RELATED APPLICATION

This application claims priority to Japanese Patent Application No. 2023-208677 filed on Dec. 11, 2023, incorporated herein by reference in its entirety.

### BACKGROUND

### 1. Technical Field

The present disclosure relates to a hopper having an openable and closable discharge outlet.

### 2. Description of Related Art

Japanese Unexamined Patent Application Publication No. 2019-18966 (JP 2019-18966 A) discloses a powder feeder that can prevent formation of bridging and can adjust the presence of air in powdery materials.

### SUMMARY

Common problems regarding hoppers may include formation of bridging. If bridging is formed in a hopper in a factory, for example, it is necessary to stop the line and remove the bridging each time it is formed, which might be a factor to hinder the efficiency of a manufacturing process.

JP 2019-18966 A discloses one example of a solution for bridging. This example disclosed in JP 2019-18966 A has a configuration to move long members that are inserted in feeding materials along the height direction to push the feeding materials toward a discharge outlet. Such a solution might not be effective depending on the material compositions of the feeding materials. In particular, when the feeding materials are a mixture containing materials having different shapes and particle sizes, there is a concern that pushing the feeding materials in from above might rather form stronger bridging.

An object of the present disclosure is to provide a technique that can prevent formation of bridging even in a mixture containing materials having different shapes and particle sizes, which is likely to cause formation of bridging.

A first aspect relates to a hopper having an openable and closable discharge outlet.

The hopper includes a partition plate that divides an inside of the hopper into a main storage chamber connected to the discharge outlet and a sub-storage chamber not connected to the discharge outlet.

At least a part of the partition plate is a movable plate that is switchable between an opening state of opening a sub-discharge passage extending from the sub-storage chamber to the discharge outlet and a blocking state of blocking the sub-discharge passage.

A second aspect further includes the following features, in addition to the first aspect.

In discharging, the movable plate is switched from the blocking state to the opening state after the discharge outlet is opened.

A third aspect further includes the following features, in addition to the first aspect.

The partition plate includes: a first partition plate having a first movable plate; and a second partition plate having a second movable plate, and
in discharging, the first movable plate is switched from the blocking state to the opening state after the discharge outlet is opened, and the second movable plate is switched to the opening state after the first movable plate is switched again to the blocking state.

A fourth aspect further includes the following features, in addition to the first aspect.

The hopper further includes a controller that controls switching of the opening state and the blocking state in the movable plate, and
the controller controls duration time of the opening state and the blocking state in the movable plate according to an amount of feeding materials fed to the hopper, the feeding materials being stored in the sub-storage chamber.

A fifth aspect further includes the following features, in addition to any one of the first to fourth aspects.

Feeding materials that are fed to the hopper are a mixture containing at least powdery materials, a metal foil, and a resin film.

According to the first aspect, the inside of the hopper is divided into the main storage chamber and the sub-storage chamber by the movable plate. The feeding materials are discharged from each chamber, thereby preventing the concentration of the feeding materials near the discharge outlet and preventing formation of bridging.

According to the second aspect, after the discharge outlet is opened, the movable plate is switched from the blocking state to the opening state. Accordingly, it is possible to discharge the feeding materials in the main storage chamber and materials in the sub-storage chamber at different timing, respectively, thereby more reliably preventing concentration of the feeding materials near the discharge outlet.

According to the third aspect, the hopper includes the first movable plate and the second movable plate, and after the discharge outlet is opened, the two movable plates are opened and closed at different timing, respectively. Accordingly, when there is a plurality of movable plates, it is also possible to prevent concentration of the feeding materials near the discharge outlet.

According to the fourth aspect, the hopper includes the controller that controls the switching of the opening state and the blocking state in the movable plate. Accordingly, it is possible to open and close the movable plate at appropriate timing, thereby performing efficient discharging operation.

According to the fifth aspect, the feeding materials fed to the hopper are a mixture containing at least powdery materials, a metal foil, and a resin film. As described above, the hopper of the present disclosure is particularly effective in the case in which the feeding materials are a mixture containing materials having different shapes and particle diameters.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic view showing an example of an appearance of a hopper 1;

FIG. 2 is a schematic view showing an example of an internal structure of the hopper 1;

FIG. 3A is a sectional view of the hopper 1 taken along an x-z plane, showing a discharging step of the hopper 1;

FIG. 3B is a sectional view of the hopper 1 taken along the x-z plane, showing the discharging step of the hopper 1;

FIG. 3C is a sectional view of the hopper 1 taken along the x-z plane, showing the discharging step of the hopper 1;

FIG. 3D is a sectional view of the hopper 1 taken along the x-z plane, showing the discharging step of the hopper 1;

FIG. 3E is a sectional view of the hopper 1 taken along the x-z plane, showing the discharging step of the hopper 1;

FIG. 3F is a sectional view of the hopper 1 taken along the x-z plane, showing the discharging step of the hopper 1;

FIG. 4 is a schematic view showing another configuration example of the hopper 1;

FIG. 5 is an x-y plan view showing still another configuration of the hopper 1; and

FIG. 6 is an x-y plan view showing still another configuration of the hopper 1.

### DETAILED DESCRIPTION OF EMBODIMENTS

With reference to the accompanying drawings, the embodiments of the present disclosure will be described.

### 1. Configuration of Hopper

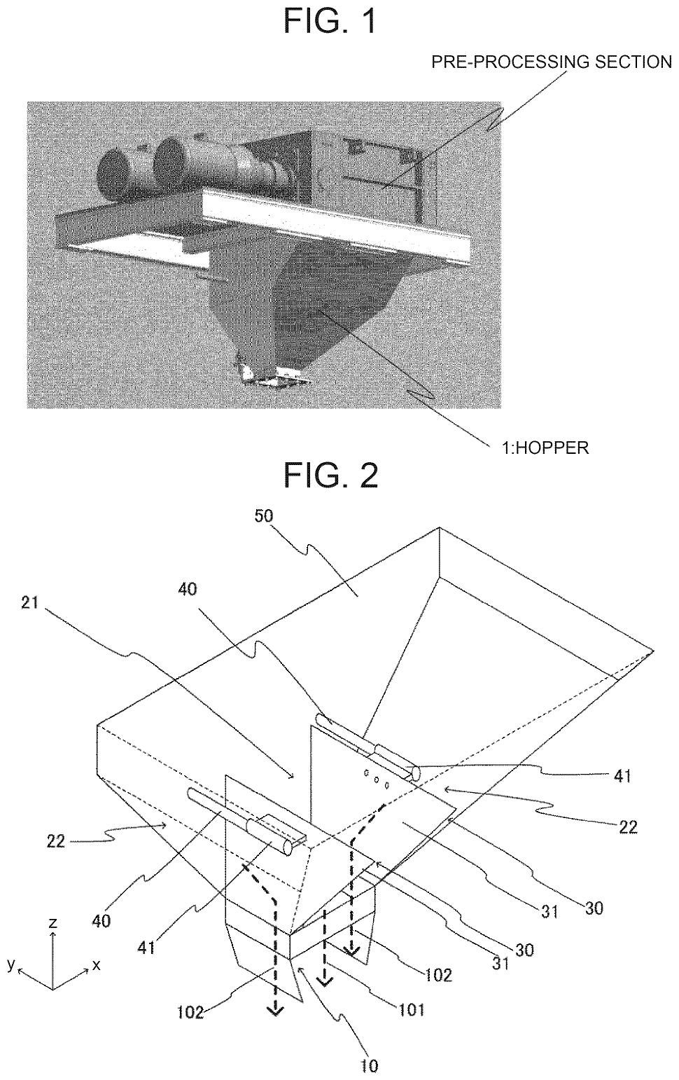

FIG. 1 is a schematic view showing an example of an appearance of a hopper 1. The hopper 1 is disposed in a factory or the like and is fed with materials processed in a previous processing step. The hopper 1 discharges feeding materials having been fed from a discharge outlet 10 after temporarily storing the feeding materials and conveys the feeding materials to a subsequent processing step. As the subsequent processing step after the hopper 1, the feeding materials may be conveyed directly to a different device or to another processing step by using a conveyor belt or the like. In the example shown in FIG. 1, the hopper 1 is directly connected to a pre-processing section serving as the previous processing step. The feeding materials fed to the hopper 1 are not particularly limited as far as the feeding materials are a fluid substance, such as powdery or granular materials.

FIG. 2 is a schematic view showing an example of an internal structure of the hopper 1. For convenience of simple illustration of the internal structure, a side wall 50 of the hopper 1 is partially omitted from the drawing. Dashed lines in the drawing show an external shape of the omitted part. FIG. 2 and subsequent drawings are provided with x-, y-, z-axes, respectively. The z-axis indicates a perpendicular direction, and the x-axis and the −y axis are orthogonal to each other while both are orthogonal to the z-axis. The y-axis is defined such that a plane along which a partition plate 30 described later extends is parallel to the yz-plane.

The side wall 50 is typically configured by joining a plurality of metal plates by welding or the like. In an example shown in FIG. 2, the side wall 50 is configured by combining flat plates but may also be configured to have curved surfaces.

The discharge outlet 10 is located at a lower end of the hopper 1. The discharge outlet 10 is openable and closable. Specifically, as shown in FIG. 2, double action doors are exemplified; and an aspect of using a sliding door or the like is also exemplified.

The hopper 1 further includes a partition plate 30. The partition plate 30 divides the inside of the hopper 1 into a main storage chamber 21 and a sub-storage chamber 22. The main storage chamber 21 is a space connected to the discharge outlet 10, and the sub-storage chamber 22 is a space not connected to the discharge outlet 10. A passage extending from the main storage chamber 21 to the discharge outlet 10 is defined as a main discharge passage 101. At least a part of the partition plate 30 is movable and this part is specifically referred to as a movable plate 31. The movable plate 31 can be switched between an opening state of opening a sub-discharge passage 102 extending from the sub-storage chamber 22 to the discharge outlet 10 and a blocking state of blocking the sub-discharge passage 102. The number of partition plates 30 is not limited to a particular number and may be only one or more. In the example shown in FIG. 2, two partition plates 30 are provided, and they both function as the movable plates 31. The two partition plates 30 (movable plates 31) extend parallel to the yz-plane. In the example shown in FIG. 2, the two partition plates 30 (movable plates 31) are in the blocking state. The partition plate 30 does not have to entirely divide the inside of the hopper 1, but can be configured to partition a part of the inside close to the discharge outlet 10, as in the example shown in FIG. 2.

The movable plate 31 is switched between the opening state and the blocking state via movement of an opening-closing device 40. In the example of FIG. 2, the opening-closing device 40 has a rotating body 41 that rotates about an axis extending in the y direction. The rotating body 41 and the movable plate 31 are mechanically joined to each other by bolts. As the rotating body 41 rotates, the state of the movable plate 31 joined to the rotating body 41 is switched. In FIG. 2, two rotating bodies 41 are attached on the sub-storage chambers 22 side of two surfaces of the movable plates 31, or they may be attached on the main storage chamber 21 side of two surfaces of the movable plates 31, instead.

Each opening-closing device 40 includes the rotating body 41 located inside the hopper 1 and a driving device located outside the hopper 1 (not shown). The rotating bodies 41 are rotationally driven by the driving device located outside the hopper 1. The driving device of the opening-closing devices 40 includes a pneumatic cylinder or a hydraulic cylinder, which can rotate the rotating bodies 41 by converting a reciprocating motion of the cylinder into a rotational motion via a crank mechanism or the like. The operation of the opening-closing devices 40 are typically controlled automatically by a controller. As another aspect, the opening-closing devices 40 may be mechanically moved by a person (e.g. a worker), or the opening-closing devices 40 may perform a pre-set operation when a person presses a switch. The controlling method of the opening-closing devices 40 by the controller will be described below.

### 2. Discharging Step

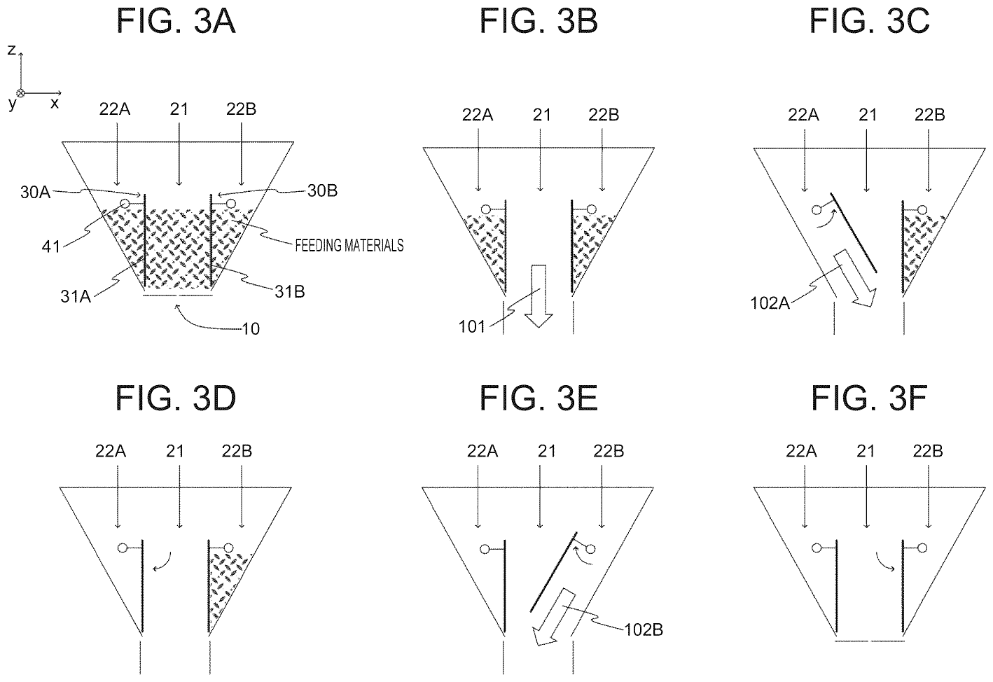

FIGS. 3A, 3B, 3C, 3D, 3E, 3F are sectional views of the hopper 1 taken along the x-z plane, showing the discharging step of the hopper 1. As in FIG. 2, the two partition plates 30 (movable plates 31) are provided. In this example, the two partition plates 30 are distinguished as a first partition plate 30A and a second partition plate 30B. As in FIG. 2, the first partition plate 30A functions as a first movable plate 31A and the second partition plate 30B functions as a second movable plate 31B. The sub-storage chamber 22 formed by the first movable plate 31A is referred to specifically as a first sub-storage chamber 22A, and the sub-storage chamber 22 formed by the second movable plate 31B is referred to specifically as a second sub-storage chamber 22B. The discharging step of discharging the feeding materials from the hopper 1 will be described below.

FIG. 3A shows a state in which the feeding materials are stored. At this time, the discharge outlet 10 is closed, and the first movable plate 31A and the second movable plate 31B are both in the blocking state. The height of the feeding materials stored in each storage chamber is preferably located lower than a top end of each movable plate 31.

First, the discharge outlet 10 is opened. Therefore, the main discharge passage 101 extending from the main storage chamber 21 to the outside of the discharge outlet 10 is opened, and the feeding materials stored in the main storage chamber 21 adjacent to the discharge outlet 10 are discharged (see FIG. 3B).

Next, the first movable plate 31A is switched from the blocking state to the opening state. Therefore, the first sub-discharge passage 102A extending from the first sub-storage chamber 22A to the discharge outlet 10 is opened, and the feeding materials accumulated in the first sub-storage chamber 22A are discharged (see FIG. 3C).

Next, the first movable plate 31A is switched from the opening state to the blocking state. That is, the first sub-discharge passage 102A is blocked (see FIG. 3D).

Then, the second movable plate 31B is switched from the blocking state to the opening state. As a result, the second sub-discharge passage 102B extending from the second sub-storage chamber 22B to the discharge outlet 10 is opened, and the feeding materials accumulated in the second sub-storage chamber 22B are discharged (see FIG. 3E). At this point, the feeding materials having been fed to the hopper 1 are discharged completely. Note that the second movable plate 31B is switched from the blocking state to the opening state after the first movable plate 31A is switched from the opening state to the blocking state, and this is for the purpose of preventing interference between the movable plates 31, and also increasing the range of movement of the movable plate 31 which moves later (in this case, the second movable plate 31B).

Next, the discharge outlet 10 is closed. The second movable plate 31B is switched from the opening state to the blocking state, thereby blocking the second sub-discharge passage 102B (see FIG. 3F). As a result, the state is set to the same state as in FIG. 3A, and new feeding materials can be fed to the hopper 1. By repeating the series of processing shown in FIGS. 3A, 3B, 3C, 3D, 3E, 3F, the hopper 1 can continuously discharge the feeding materials.

Here, the movable plates 31 may be repeatedly switched several times during one processing step. For example, in FIG. 3C, in the case of performing opening-closing (switching from the blocking state to the opening state) is performed only once, the feeding materials might remain near the joint part between the opening-closing device 40 and the first movable plate 31A. In order to reliably discharge the feeding materials, the first movable plate 31A may be opened and closed several times in FIG. 3C. The above description can also be applied to the second movable plate 31B in FIG. 3E.

### 3. Effects

Common problems regarding a hopper may include formation of bridging. Bridging is an arch-like aggregate structure formed to cover a discharge outlet by feeding materials during discharging. The bridging is formed when concentration of the feeding materials towards the discharge outlet generates pressure in the feeding materials as well as frictional resistance in the feeding materials and or between the feeding materials and the hopper, which makes it difficult for the feeding materials to slide, causing the feeding materials to entangle with each other. If bridging is formed in the hopper, for example, it is necessary to stop the line and remove the bridging each time it is formed, which might be a factor to hinder the efficiency of the processing step.

As described above, the related art disclosed in JP 2019-18966 A has a configuration to move the long members inserted in the feeding materials along the height direction to push the feeding materials towards the discharge outlet. Such a solution might not be effective depending on the material compositions of the feeding materials. In particular, when the feeding materials are a mixture containing materials having different shapes and particle sizes, there is a concern that pushing the feeding materials in from above might rather form stronger bridging.

In the present disclosure, the inside of the hopper 1 is divided by the partition plates 30, and the feeding materials in each chamber are separately discharged, thereby preventing formation of bridging. The effects of the present disclosure will be described with reference to FIGS. 3A, 3B, 3C, 3D, 3E, 3F.

In FIG. 3B, the feeding materials accumulated in the main storage chamber 21 fall (are discharged) with little resistance because the movable plates 31 are set in the perpendicular direction. In addition, by partitioning with the movable plates 31, concentration of the feeding materials is unlikely to be caused near the discharge outlet 10.

In FIG. 3C, although the side wall 50 of the hopper 1 has a constant slope and resistance is generated, no concentration of the feeding materials is caused because the feeding materials are not discharged from the other directions (from the main storage chamber 21 or the second sub-storage chamber 22B).

Due to the above actions, the hopper 1 of the present disclosure reduces formation of bridging. This can contribute to improvement of working efficiency in a factory or the like.

The hopper 1 of the present disclosure does not push the feeding materials in from above; therefore, it is also effective in the case in which the feeding materials are a mixture containing materials having different shapes and particle diameters that are likely to form bridging. For example, in batteries used in battery electric vehicles, various materials such as metal and resin are used, and in the case of crushing the materials for recycling, the crushed materials become a mixture having different shapes and particle diameters, including powdery materials, metal foils, and resin films. Therefore, the hopper 1 of the present disclosure particularly exerts effects when the hopper is used in a step of crushing and recycling used batteries.

### 4. Control on Opening-Closing Device by Controller

The case where the opening-closing device 40 is controlled by a controller is considered. The controller controls the switching of the opening state and the blocking state of the movable plates 31 via the opening-closing device 40. That is, the controller controls duration time of the opening state and the blocking state of the movable plates 31. In particular, when the duration time of the opening state is too short, the feeding materials are not discharged completely, and efficiency of the discharging is reduced. On the other hand, when the duration time of the opening state is too long, it takes some time until the processing proceeds to a next step even after the accumulated feeding materials are discharged completely, which is inefficient. Hence, in light of efficiency of the discharging step, it is important to appropriately control the duration time of the opening state of the movable plates 31.

The larger the amount of accumulated feeding materials becomes, the longer it takes to discharge the feeding materials. Therefore, it is desirable to adjust (control) the duration time of the opening state according to the amount of accumulated feeding materials. In other words, it is reasonable that the larger the amount of accumulated feeding materials becomes, the longer the duration time of the opening state is set to be; and on the other hand, the smaller the amount of accumulated feeding materials becomes, the shorter the duration time of the opening state is set to be.

The amount of accumulated feeding materials may be detected such that a pressure sensor is mounted on the movable plate 31 or the side wall 50 to measure the pressure generated by the feeding materials. When the driving device of the opening-closing device 40 includes a cylinder, the duration time of the opening state may be controlled according to the load (resistance force) of the cylinder required to keep the blocking state.

### 5. Other Configuration Examples

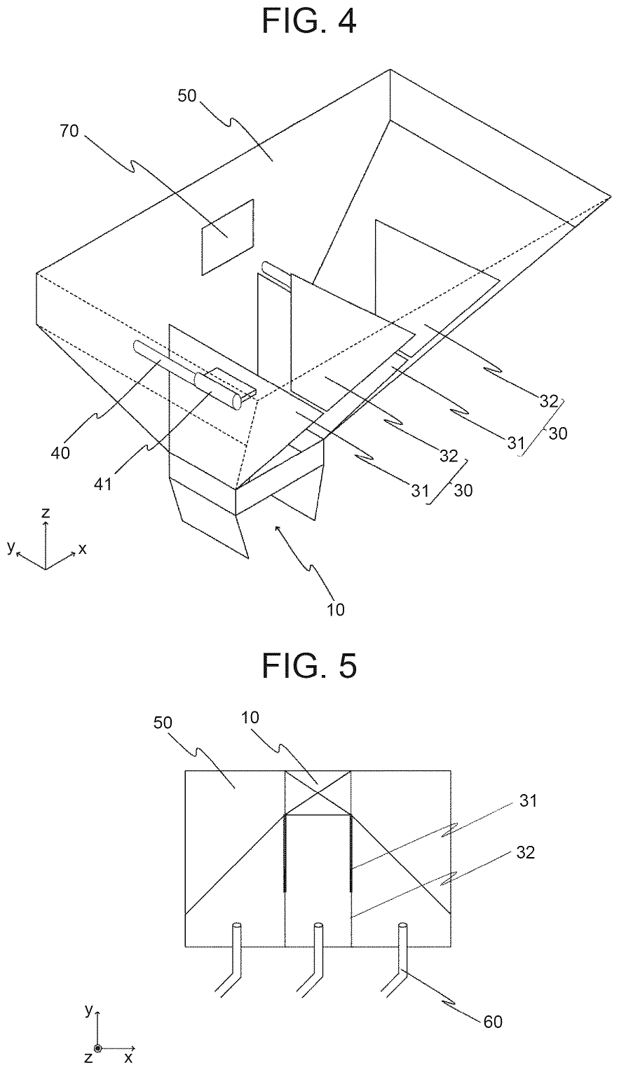

FIG. 4 shows a schematic diagram of another configuration example of the hopper 1. In this case, the illustrations of the components already shown in FIG. 2 are omitted.

The hopper 1 includes an inspection hole 70. The inspection hole 70 is installed in the side wall 50 for the purpose of allowing a person to visually check whether or not the feeding materials are properly discharged. The inspection hole 70 is preferably made of tempered glass or the like.

In addition to the movable plate 31, each partition plate 30 includes a rectifying plate 32, which is different from the movable plate 31. The rectifying plate 32 is typically formed of a metal plate and is fixed to the side wall 50 of the hopper 1 by welding. Unlike the movable plate 31, the rectifying plate 32 includes no opening-closing mechanism and is provided so as to appropriately distribute the feeding materials fed from above to the main storage chamber 21 and the sub-storage chambers 22. The rectifying plate 32 does not have to extend to the other wall surface of the wall of the hopper 1. For example, in the example in FIG. 4, it is assumed that the hopper 1 mainly receives the feeding materials in a part (on the opposite side of the wall where the inspection hole 70 is installed) of the side wall 50, and the rectifying plate 32 is disposed only to the part where the feeding materials are mainly received.

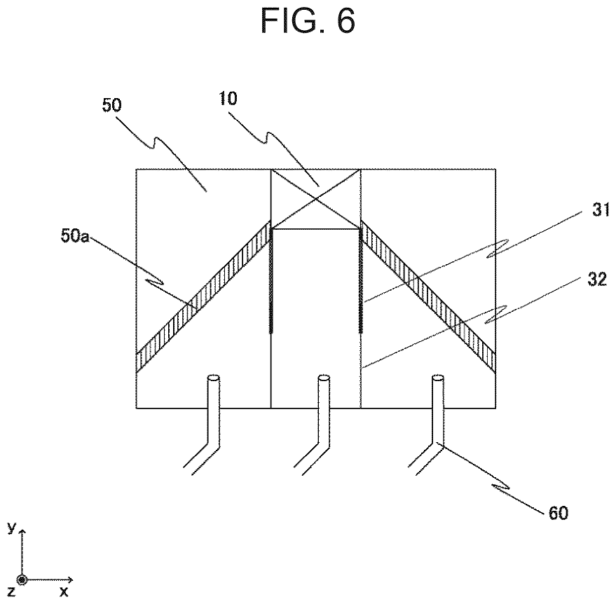

FIG. 5 is an xy-plan view showing still another configuration example of the hopper 1. The hopper 1 includes air blowers 60. The air blowers 60 are located near a charge inlet of the hopper 1 and inject air along the wall of the hopper 1 towards the bottom of the hopper 1. As a result, the feeding materials having not been discharged by the operation of the movable plates 31 and still remaining in the hopper 1 are blown off toward the bottom of the hopper 1 by the air. In this case, three air blowers 60 in total are installed in the main storage chamber 21 and in each of the two sub-storage chambers 22, respectively. FIG. 6 is an xy-plan view showing still another configuration example of the hopper 1. The side wall 50 of the hopper 1 includes a plurality of flat plates. In addition, inside the hopper 1, connecting plates 50a are attached along joints between the flat plates. The connecting plates 50a allow the flat plates to have a gentle angle between them via the connecting plates 50a. In the case of having no connecting plates 50a (e.g. in the configuration shown in FIG. 5), the flat plates intersect with each other at a sharp angle between them. In the hopper 1 including the flat plates combined with each other, the intersection part intersecting at a sharp angle has a deep valley-like shape. In this case, the plates are more likely to be subjected to frictional resistance from the side wall 50, and the feeding materials tend to be accumulated; and consequently, the feeding materials are not discharged completely and easily remaining. The connecting plates 50a reduce this valley-like shape, so that the feeding materials can be more easily discharged. The side wall 50 may be manufactured to be originally formed with the connecting plates 50a, or the side wall 50 may be once manufactured to be formed with no connecting plates 50a, and the connecting plates 50a may be additionally formed by welding later on.

What is claimed is:

1. A hopper comprising: an openable and closable discharge outlet; and
a partition plate that divides an inside of the hopper into a main storage chamber connected to the discharge outlet and a sub-storage chamber not connected to the discharge outlet,
at least a part of the partition plate being a movable plate that is switchable between an opening state of opening a sub-discharge passage extending from the sub-storage chamber to the discharge outlet and a blocking state of blocking the sub-discharge passage.

2. The hopper according to claim 1, wherein
in discharging, the movable plate is switched from the blocking state to the opening state after the discharge outlet is opened.

3. The hopper according to claim 1, wherein
the partition plate includes: a first partition plate having a first movable plate; and a second partition plate having a second movable plate,
in discharging, the first movable plate is switched from the blocking state to the opening state after the discharge outlet is opened, and the second movable plate is switched to the opening state after the first movable plate is switched again to the blocking state.

4. The hopper according to claim 1, further comprising a controller that controls switching of the opening state and the blocking state in the movable plate, wherein
the controller controls duration time of the opening state and the blocking state in the movable plate according to an amount of feeding materials fed to the hopper, the feeding materials being stored in the sub-storage chamber.

5. The hopper according to claim 1, wherein feeding materials that are fed to the hopper are a mixture containing at least powdery materials, a metal foil, and a resin film.
